(19) United States
(12) Patent Application Publication
(10) Pub. No.: US 2011/0299267 A1
(43) Pub. Date: Dec. 8, 2011

(54) Light capturing generator and distributor

(76) Inventor: Leif Eric Tobias Levon, Alta (SE)

(21) Appl. No.: 13/135,284

(22) Filed: Jul. 1, 2011

(30) Foreign Application Priority Data
Apr. 20, 2011 (GB) GB1106639.6

(51) Int. Cl. F21V 7/00; F21V 9/16

(52) U.S. Cl. 362/84; 362/307

(57) ABSTRACT

A methodological approach of achieving a systematic exchange of light by employment and interplay of photo optic bodies via transmissive mediums. The present invention provides a synaptical junction or medium of exchange between optic bodies so that energy in the form of light, following behavioural patterns of waves and particles, may mutually be exchanged. Incidental rays are methodically counter reflected between neighbouring optic bodies with resultant dispersion and separation of various wavelengths. Several benefits accrue from this rendez-vous of optical bodies within the confines of a Light Distributor. Light can be more readily re-directed within 360 degrees and concentrated toward specific target areas. The unit has retro-reflective properties and generates a secondary visible light which may be reflected to all cardinal points.

### FIELD OF INVENTION

Illumination systems. Effective transference and transformation of a variety of wavelengths of light from a primary light source or energy derived from within the electromagnetic spectrum in order to illuminate one or more optic bodies.

### BACKGROUND OF THE INVENTION

Light distributing units are used to capture and direct ambient light or light from a specific light source to more than one direction. Units may be composed of an internal or external light source, optic bodies, reflectors, mediums of exchange as well as lenses and prisms or suitable combinations of these.

Light distribution units may also be used to create chromatic effects or mix light and achieve planar light. Other uses may include altering wavelengths of light so that light of short wavelength may be readily converted into more visible light of longer wavelengths or vice versa. All kinds of electric, magnetic, visible and invisible radiation of short and long wavelength within the electromagnetic spectrum may be involved in conversion of light. Further examples may involve microwaves, or surrounding high energy fields that charge electrons within noble gases with resultant emission of light. Light Distributing Units may utilize energy derived from within the electromagnetic spectrum though mainly ambient light, sunlight or artificial light are generally the norm. Certain matter within the Light Distributing Unit may be exposed to radiant energy or radiation in order to emit light. For example phosphor may fluoresce when exposed to ultra violet rays and luminescent materials may luminesce when exposed to light of either short or long wavelength. Special materials such as uranium glass contains radioactive metallic elements derived from pitchblende which may be a suitable active ingredient within certain optic bodies since it is highly fluorescent. Light may even originate from induced currents, high energy fields and chemical reactions occurring within or outside the Light Distributing Unit.

### SUMMARY OF THE INVENTION

The object of the present Light Distributing Unit is to be able to collect and use a variety of natural or artificial light producing sources and re-distribute light rays in an energy saving functional manner. Capturing and concentrating diffuse surrounding ambient light or light from distant light sources in order to generate and emit a secondary visible light source within reflecting chamber and/or optic bodies as well as utilizing auxiliary coupled electrically activated light supply units. Linearly aligned optic bodies receive and transmit light favourably between each other, since light tends to travel in straight lines. In order to disburse and distribute light more equally between a cluster of photo optic bodies, mirrors and prisms may be employed to change directions of light beams. Optic bodies arranged radially around a hexagonal structure tend to distribute light in a bias way since three pairs of optic bodies are similarly aligned and would therefore receive most light. However optic bodies radially mounted pentagonally may face mirrors which will force light to change direction and target specific chosen optic bodies. Light Distribution Units may act as general utility primary or secondary light sources and replace standard bulbs and lamps or function as reflecting devices suitable for safety purposes, ornaments and fashion items as well as road markers and general transport infrastructure. Standard light pipes and optical fibres do not generally concentrate light from one optic body to another. In order to achieve an effective transfer of light between optic bodies they must be in close proximity to one another. Proximately arranged optic bodies are able to co-operatively exchange light directly to one another as well as via specular and diffuse reflection off surrounding reflecting surfaces.

Very flat and smooth reflecting surfaces permit light rays to bounce off in a concentrated fashion. This intense light is then mutually directed toward neighbouring optic bodies. Reflection may of course occur via curved reflective surfaces such as concave and hyperbolic shapes. These phenomena may be employed to generate or emit a secondary light issuing from one or more optic bodies partly contained within a reflecting chamber. Alternatively optic refractive bodies may be integrated with reflective surfaces along specific zones acting as exits and entrances of light. Ambient light may be received by one or more optic bodies surrounded by external light capturing reflectors or lenses. Receiving optic bodies in turn supply light via windows leading into a reflecting chamber or cell housing auxiliary optic bodies.

In many respects the Light Distribution chamber resembles an optical synaptic junction or light distribution terminal between light receiving and transmitting optic bodies and components.

The present invention provides a synaptical junction or medium of exchange between optic bodies so that energy in the form of light, following behavioural patterns of waves and particles, may be mutually exchanged within this confined reflecting chamber. The physical gap occurring between at least one reflective surface, within the Light Distribution chamber, and one or more optic bodies will alter the angle of incidence as rays are counter reflected toward neighbouring optic bodies and in the process alter wave lengths while passing from one medium to the other. Mirrors are specifically directed in sequence corresponding to incidental and reflective rays enabling mutual exchange of light between optic bodies.

Light changes speed and direction due to refraction within the Light Distribution chamber with resultant dispersion and separation of various wavelengths. Several benefits accrue from this rendez-vous of optical bodies within the confines of the chamber. Light can be more readily re-directed within 360 degrees and concentrated toward specific target areas.

Optical bodies will transmit brighter sharper light than if standard internal reflection of light pipes and guides were employed per se. Light of shorter wavelength may be readily converted to more visible light of longer wavelength while passing through the physical gap occurring between optic bodies as light is influenced by the medium of exchange. Photons and electrons within the junction or gap it's self may become excited by incoming light or other energy within the electromagnetic spectrum and thereby release additional photons to receptive optic bodies.

Light Distributing units consist of at least one light receiving optic body and at least one light emitting optic body operating in conjunction with an internally reflecting light Distributing chamber. Optic bodies and light distribution chambers mutually interact with each other so that light effectively flows between all coupled optic bodies. There exists at least a two way flow of radiant energy between two or more optic bodies. These optic bodies may in turn function as receivers and transmitters per se. Thus at least two optic bodies may simultaneously receive and transmit light to and from a Light Distributing chamber.

Optic bodies may also receive and transmit light between each optic body via the confined space within reflecting chambers. Alternatively optic bodies may be fused directly with each other or via a prism or transmissive object.

In the event that optic bodies are fused into a single unified unit light may still be counter reflected via a junctional reflective gap within a reflective chamber. Light Distributing units aid in the transmission of light between optic bodies by acting as passageways for light to reflect and follow. There may exist a spaced relation between optic bodies within Light Distributing chambers or optic bodies may be suitably coupled to one another via a medium of gas, solid, liquid or gel or they may appear as a united single unit. Light alters frequency as it passes one medium to another and may therefore appear more visible to the human eye the longer the wavelengths convert to. Optic bodies may be made of solids, liquids, gases or gels and contain dyes with or without fluorescent properties. Optic bodies may comprise pressurized or vacuum capsules or vessels containing suitable transmissive substances. An optimal orientation may be defined as a state wherein at least one optic body, penetrating an internally reflecting chamber, is in perfect or approximate alignment to the path of the incident ray interacting with at least a second optic body in perfect or approximate alignment to the reflected ray with respect to the normal of a planar reflective surface. Thus in accordance to the law of reflection the angle of a first optic body should correspond the angle of incidence and the angle of a second optic body to the angle of reflection. This entails that if the angle from the normal is 90 degrees then optic bodies are positioned at 90 degrees along an x and y axis. A state of optimal concentration exists when light reflects directly from one adjoining optic body to another via a flat reflective surface as opposed to multiple intermediary reflections occurring between points of transfer. Two phase specular reflection between optic bodies coupled to a light distribution chamber may still provide each interacting body interchangeably with concentrated light for illumination purposes. A plurality of reflectors may be set up in this manner so that light may strike optic bodies from a variety of directions. Surfaces of optic bodies may be multifaceted with protrusions and intrusions in order to increase receiving and transmitting surface areas. Light Distributing Unit chambers may likewise be in a pressurized or vacuum state. Suitable solids, liquids or gases with or without added organic or inorganic dyes may also fill reflection chambers.

At least two optic bodies project or extend out from a Light Distributing chamber. Ambient light or light from distant light sources concentrate onto at least one primary receiving optic body. This light is further reflected and or refracted within the Light Distributing chamber in order to project out from at least another accompanying juxtaposed secondary optic body also extending from the Light Distributing chamber. This procedure may occur in reverse so that a secondary optic body acts as receiver of light and a primary optic body as a transmitter of light. Both primary and secondary optic bodies may simultaneously receive and transmit light via the Light Distributing chamber. Thus any optic body coupled to the Light Distributing chamber will influence all other adjoining optic bodies. This entails that multiple optic bodies will emit more light if each single optic body simultaneously receives the same quantity of light or Lux/Candela due to the mutual arrangement, than if only one optic body receives light per se. Light appears more visible too as wavelengths become longer due to fluorescent and luminescent activity occurring internally within reflection chambers or externally within optic bodies themselves. Light of various colours may be received by two or more optic bodies and this light may in turn be mixed within the Light Distributing chamber so that white light or any desirable colour may issue out of one or more designated optic bodies. Likewise light emitting diodes may also comprise coloured samples which blend within a Light Distributing chamber before issuing out as white light from designated optic bodies. Light entering a Light Distributing unit may activate phosphorescent or luminescent substances housed within a Light Distributing chamber and this converted light may in turn escape via a receiving optic body and/or via any adjoining optic bodies. A multitude of optic bodies coupled to a Light Distribution chamber will allow light to be perceptible 360 degrees. Light of any kind may be introduced directly into the Light Distributing Unit via one or more implanted diode lamps suitably mounted along one of the Light Distributing chamber's sides. Light emitting diodes may be powered by photovoltaics, thermoelectrics, induced currents derived between primary and secondary coils or standard mains supply units.

Other forms of energy such as microwaves, high energy fields or transference of currents from a distant primary coil to a secondary coil close to the Light Distribution Unit may excite luminescent/fluourescent material within its reflective chamber to a higher energy state and release photons and visible light through adjoining optic bodies.

Emitted light may be further regulated by polarizing layers surrounding optic bodies. When the polarizing layers are influenced by currents they act as shutters hindering light from entering or escaping from the Light Distributing Unit.

Light Distributing chambers may be lined by reflective materials and/or luminescent/fluorescent/phosphorescent layers. These layers may in turn be covered by polarizing particles so that they are intermittently influenced by approaching light rays. This will cause the unit to flicker and blink or deliver a variety of chromatic displays.

Light emitting diodes combined with Light Distributing Units perform more favourably since projected light emanating from Light emitting diodes will be uniformly spread by reflecting chamber followed by emission from optic bodies exteriorly.

This is achieved by inserting one or more light emitting diodes along one or more sides of the Light Distributing Unit's chamber so that internally projected light comprising collimated, divergent and convergent rays may be counter reflected by internal reflective surfaces and escape through one or more mutually coupled optic bodies extending from one or more apertures. Light may of course be further projected by additional reflectors surrounding optic bodies exteriorly. Light emitting diodes should preferentially project light in a direction which concurs to the angle of incidence so that it equals the angle of reflection when counter reflected toward one or more optic bodies in order to illuminate said optic bodies. Light emitting diodes may also phosphoresce/fluoresce/luminesce substances within the internally reflecting Light Distributing Unit's chamber. These special substances may line parts of the chamber's walls or appear as dots and stripes among reflective surfaces.

In practice Light Distributing units will appear to function as energy saving incandescent or fluorescent light bulbs.

Both optic bodies and Light Distributing chambers may employ nano technology such as phosphor dots and quantum dots in order to enhance illumination. Nano technology will improve reception, reflection, refraction, transmission and emission of light. Nano-crystallines of rare earth complexes may be synthesized by chemical precipitation methods and integrated with optic bodies. Colloidal quantum dots or nanoparticles having narrow emission spectra may enhance excitation of a broad variety of colour spectra utilizing only one wavelength with resultant prolonged fluorescence. Quantum dots are photo stable and brighter than organic dyes with relative long longevity. Nano technology may be employed as layers, dots or embedded particles within optic bodies and Light Distributing chambers.

Optic bodies may be of regular or irregular shapes with perfect or approximate optical features or more specific shapes such as rhomboids, rhombi, pyramidal, polygons, conical, spheres or compound parabolic concentrators. Certain shapes will enhance light receiving/transmitting ability as well as to concentrate and direct light toward reflective surfaces. For example optic bodies may have conical or pyramidal shapes extending exteriorly out from the chamber in order to receive maximal ambient light, along their surface area and spherical shapes interiorly within the chamber so that light is focused toward appropriate reflective surfaces or even counter opposing optic body members.

Hinges, swivels or pivots may be used as optional features in order to adjust angles of optic bodies.

Optic bodies may be joined externally to one another so that light converted or generated within a Light Distributing chamber may flow in a continuous looped cycle from aperture to aperture throughout the whole light distribution unit. Pyramidal or conical optic bodies may be arranged so that their proximal divergent bases originate from within a Light Distributing chamber and taper externally. Alternatively similar tapered bodies may be aligned in reverse order so that light is initially collected via large base apertures and guided in concentrated fashion towards converging apexes penetrating light distribution chambers.

Highly reflective materials may line such optic bodies in order to enhance light guiding transmission.

Regular reflectors and lenses may embrace or surround optic bodies exteriorly in order to optimize reception and transmission of light too.

Internally reflecting Light Distribution chambers may be box shaped, triangular, pyramidal or a combination of suitable shapes having plane, curved, grooved or multifaceted reflective surfaces.

Prisms may be modified into light distribution chambers and become part of a light collecting and distribution unit. Since total internal reflection takes place within prisms they act in ways which resemble internally reflecting chambers. However in order to behave in a similar vain prisms must be re-engineered since prisms working per se have certain natural characteristics which result in negative consequences for the modus operandi of light distribution units. The fact that total internal reflection takes place in the prism when the critical angle is exceed is of benefit when redirecting rays within a prism but has negative consequences when the object is to allow light to escape from the prism. In order to circumvent the so called critical angle the surface must be disrupted by a window at that particular point so that light may freely escape via a suitably lodged optic body or lens. Prisms may be suitably cast possessing optical portions behaving like optic bodies. For example bulging structural protrusions may act like lenses or Fresnel lenses may be bonded or engraved on the surfaces of prisms. Further modifications may involve internally laser engraved holographic Fresnel lenses or a variety of optic structures.

Stated modified surfaces will also allow light to freely enter the prism from a wide selection of angles and directions. Unmodified external prism surfaces also reflect approaching light rays away from the prism reducing entry into the chamber unless the angle of approach is at right angles. Optic bodies lodged in a corner section or sharp angle of a prism will also allow light to enter and exit more freely than standard unmodified versions.

Thus optically modifying prism surfaces is essential in order to gain benefit of their unique attributes. Additionally, prism surfaces may be coated with reflective materials especially when it is essential to cause reflection when total internal reflection does not occur spontaneously at certain angles within a prism. Prismatic material may contain fluorescent or luminescent constituent elements which become excited by light of various wavelengths so that additional photons are released from prisms.

### PRIOR ART

US2005/0265044; Describes a light gathering module in tapered profile mixing light and achieving planar light. However the mixing module does not describe a system and method wherein light transmitting and receiving components may work interchangeably so that they may gain a mutual benefit from each individual performance.

WO2007/036829; Demonstrates how tapering light guides may direct light to a centrally placed lens. However light gathering apparatus does not allow light to flow in reverse order. Thus optical body projects light in a proximal to distal direction only since it lacks a diversified multi-flow arrangement.

US Patent Application 2002/0065019. Describes an internal mirror of a light conducting body. Thus light is only reflected internally per se and not redirected to adjoining optic bodies.

U.S. Pat. No. 5,897,201; Exemplifies a light distribution system whereby light is radially emitted from a central light source. However the patent does not teach how light may be re-distributed back to light transmitting portions since it lacks such a technical design.

GB1473690; Depicts a light distributing unit consisting of flat rods and sheets whose end surfaces emit light in response to illumination by daylight. However reflectors are not employed to concentrate light onto optic bodies or assist in transfer of light between optic bodies.

The invention will now be described by referring to the accompanying drawings:

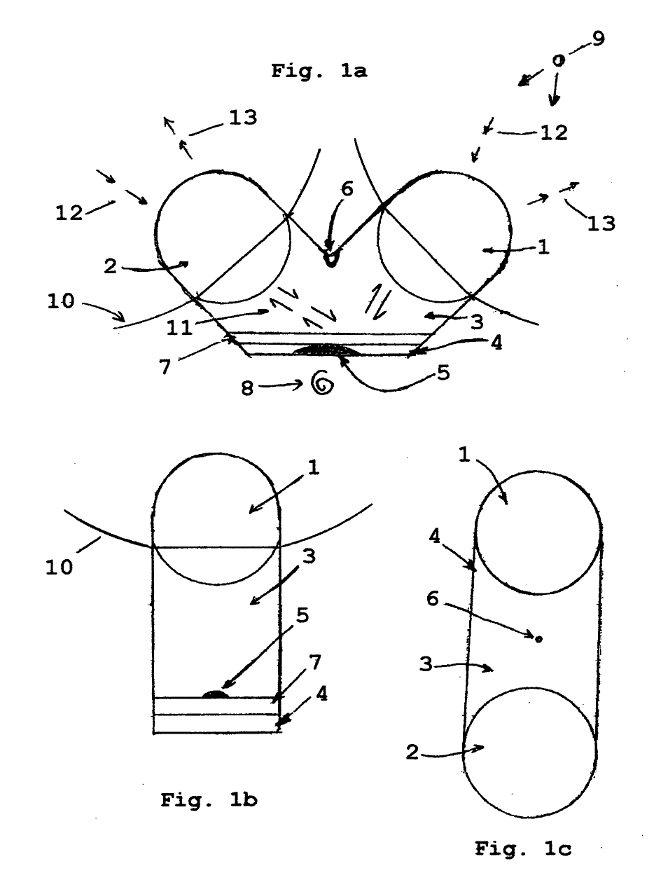

FIG. 1a; shows a longitudinal side view of a generalised Light Distributing Unit comprising primary optic body 1, secondary optic body 2, Light Distributing chamber 3, having internally reflecting walls 4, reactive phosphorescent substance 5, internal light source in the form of a light emitting diode 6, polarizing layer 7, and energy transferring secondary coil 8 receiving energy from a distant primary coil (not shown), an external distant light source 9, receiving light rays 12, transmitting light rays 13 and light collecting reflectors 10 embracing optic bodies.

FIG. 1b; depicts FIG. 1a as it will appear from a corner side view.

FIG. 1c; illustrates FIG. 1a as seen from above.

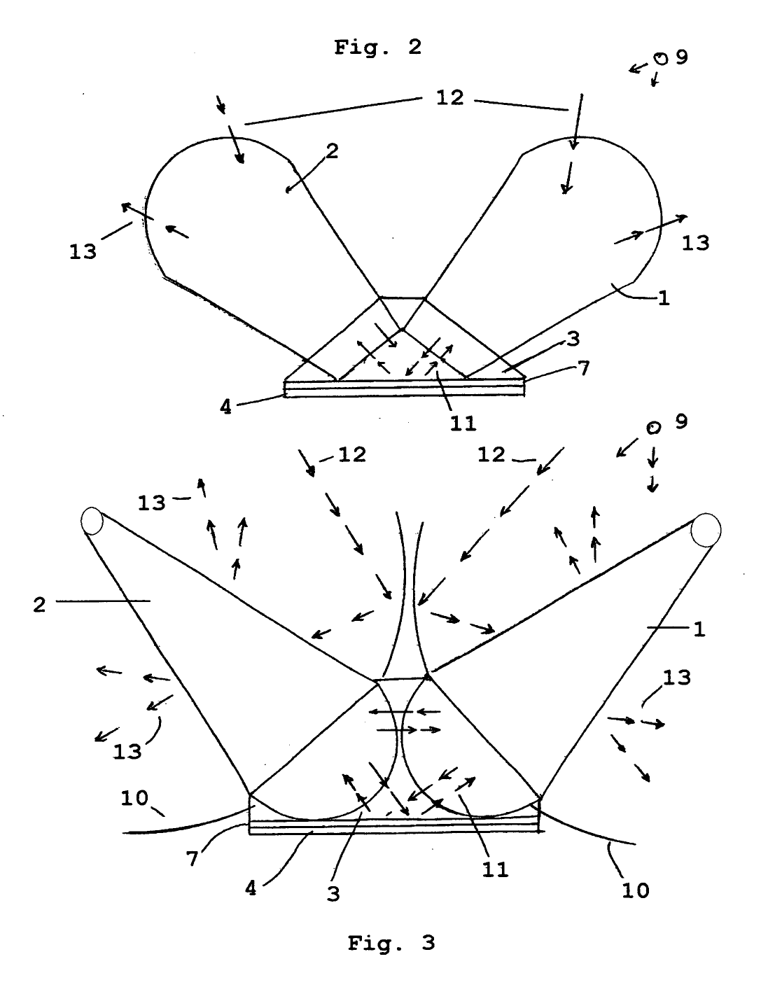

FIG. 2; shows a side view of proximally arranged convergent optical bodies with tapered ends inserted into an internally reflecting light distribution chamber enabling efficient transfer of rays via highly reflective planar surfaces.

FIG. 3; shows a side view of juxtaposed cone or pyramidally shaped optic bodies. Outward projecting portions are surrounded by reflectors and taper distally from Light Distribution chamber's aperture. Internally projecting portions of optic bodies may be in the shape of half spheres with or without multifaceted surfaces. There exists bi-directional reflection via internal mirrors as well as direct reflection across all mutually arranged optical bodies.

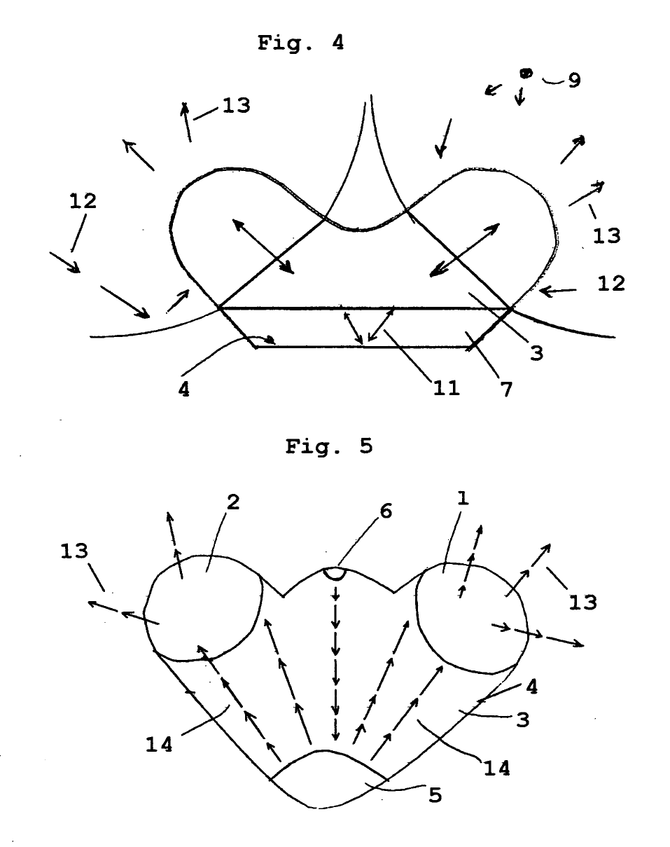

FIG. 4; demonstrates united optical bodies extending out either side of a reflection chamber. Reflecting material may line optic body unit centrally and act as an internally reflecting chamber. Alternatively there may exist a spaced relation between the floor of the optic body so that light enters a different medium before being counter reflected by specular reflection and re-entering optic body at an acute angle.

FIG. 5; drawing shows a heart shaped Light Distribution Unit with an internal light source with beams of light directed toward the lower apical part of the heart in order to phosphoresce or fluoresce material disposed in the basement depression area with resultant visible emission from both optic bodies.

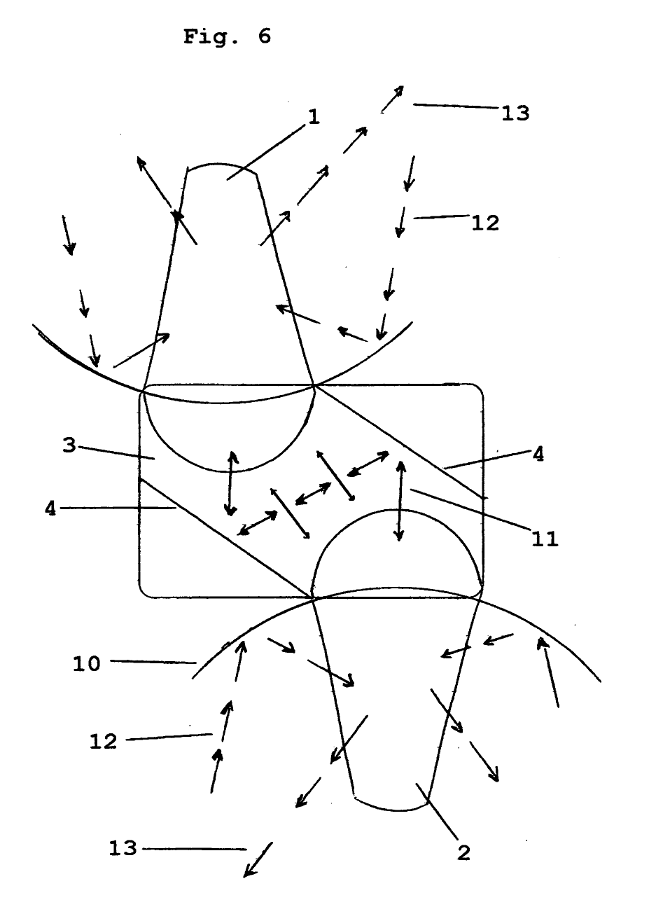

FIG. 6; At least two implanted half sphere portions of light receiving and transmitting optic bodies point diagonally toward reflectors in order to direct concentrated light obliquely between at least two planar reflectors allowing a continuous decussating flow of light.

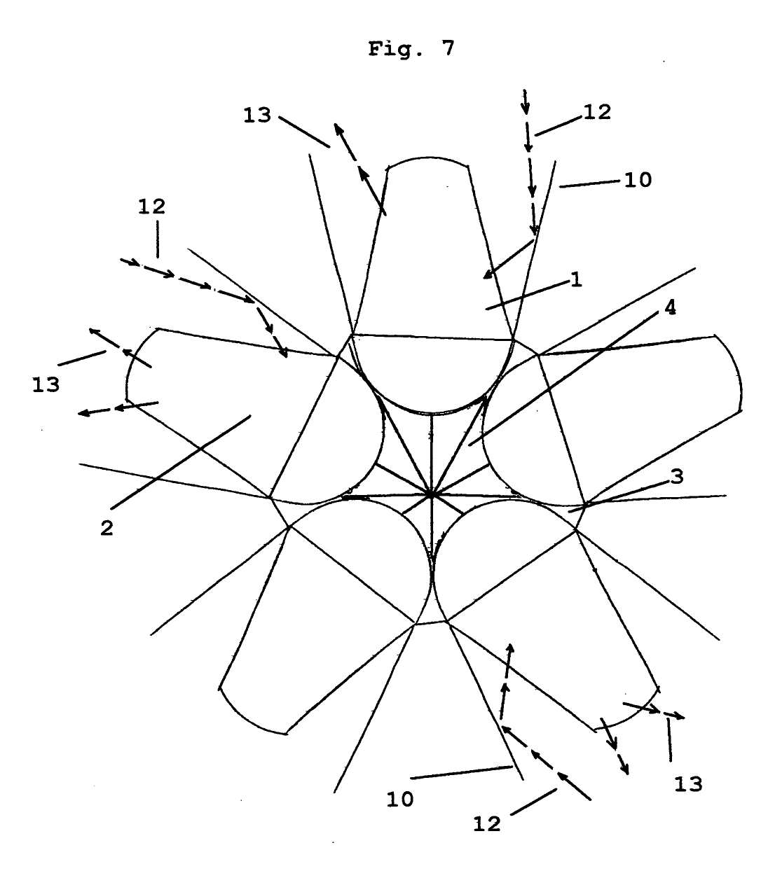

FIG. 7; An uneven number of optic bodies are directed toward a pyramidal catchment area for effective transference of rays throughout a light distributor.

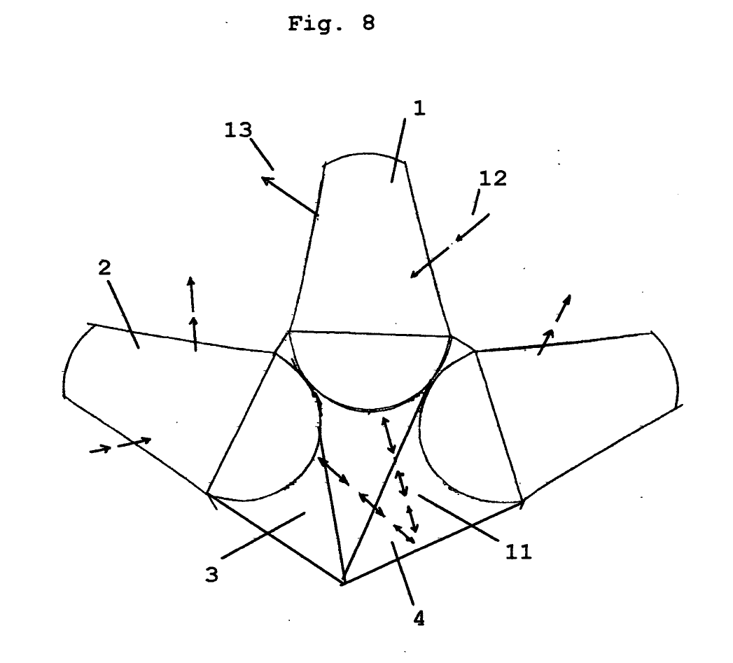

FIG. 8; An internal section of FIG. 7 is shown.

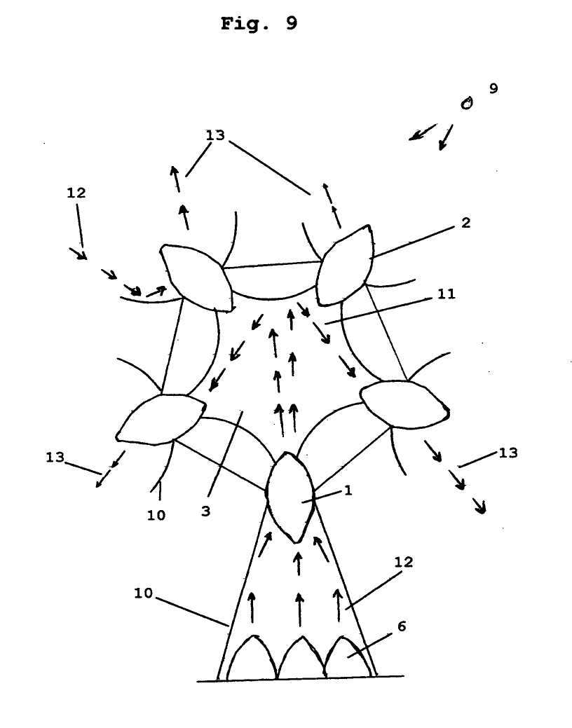

FIG. 9; Cross sectional side view of a light distribution unit receiving incoming light from a tapered light guide gathering concentrated light from a plurality of light emitting diodes as well as ambient light from the surroundings in order to illuminate opposite and adjacent optic bodies.

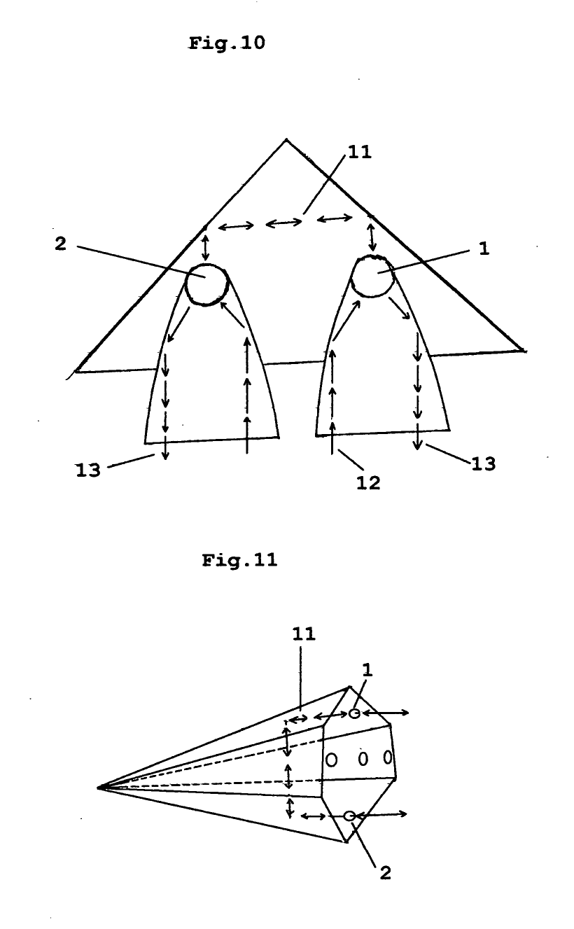

FIG. 10; Retro reflection using two cavernous or solid compound parabolic concentrators or tapering light guides.

FIG. 11; Pyramidally shaped light distribution chamber with optic bodies arranged along the divergent end so that light may be received and transmitted via optic bodies in a retro reflective manner.

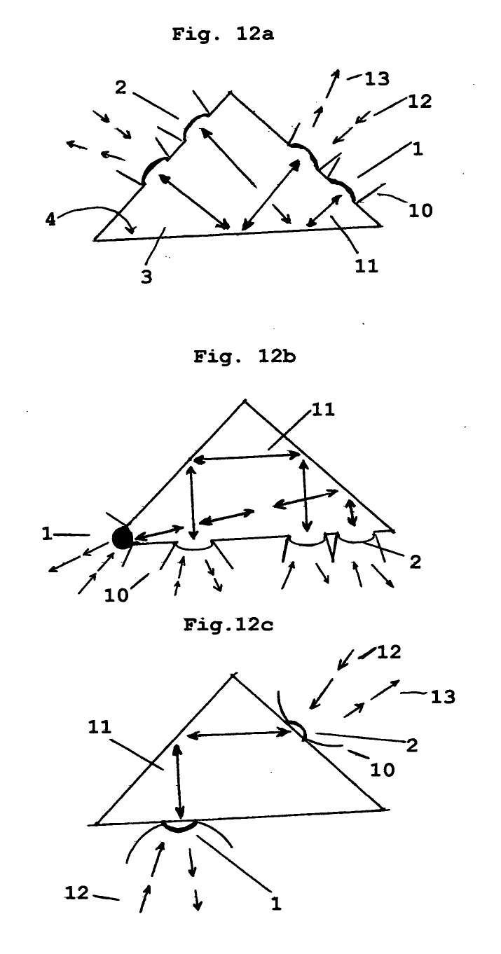

FIG. 12a,b,c; Modified versions of right angled prisms mimicking internal reflecting chambers. Reflecting surfaces are perturbed at the critical angle of reflection enabling refraction to occur instead through prismatic interface. The break in the surface permits entry and exit from a variety of incidental and reflective directions especially if special lenses such as multifaceted optical bodies or Fresnel lenses are bonded or integrated into prismatic surfaces.

FIG. 12a; A right angle triangular prism whose leg surfaces have been integrated by refracting optic bodies allowing light to be specularly reflected via planar hypotenuse internal surface with resultant mutual exchange of light between said optic components. Optical components in turn comprise external light collecting reflectors. The angle of internal reflection is dependent on placement of optic bodies as well of the length of individual legs. All types of prisms may be used including dove shaped, isosceles and trapezoid.

FIG. 12b; A right angled prismatic triangle modified by structurally cut refractive optic features integrated along the hypotenuse and hypotenuse/leg corner angle permitting mainly reciprocal exchange of light via internal specular reflection off opposing leg surfaces with chiefly a retro-reflective action.

FIG. 12c; Optic bodies made as an integral part of a right angled prism allowing exchange of light from hypotenuse to leg via specular reflection off opposing leg.

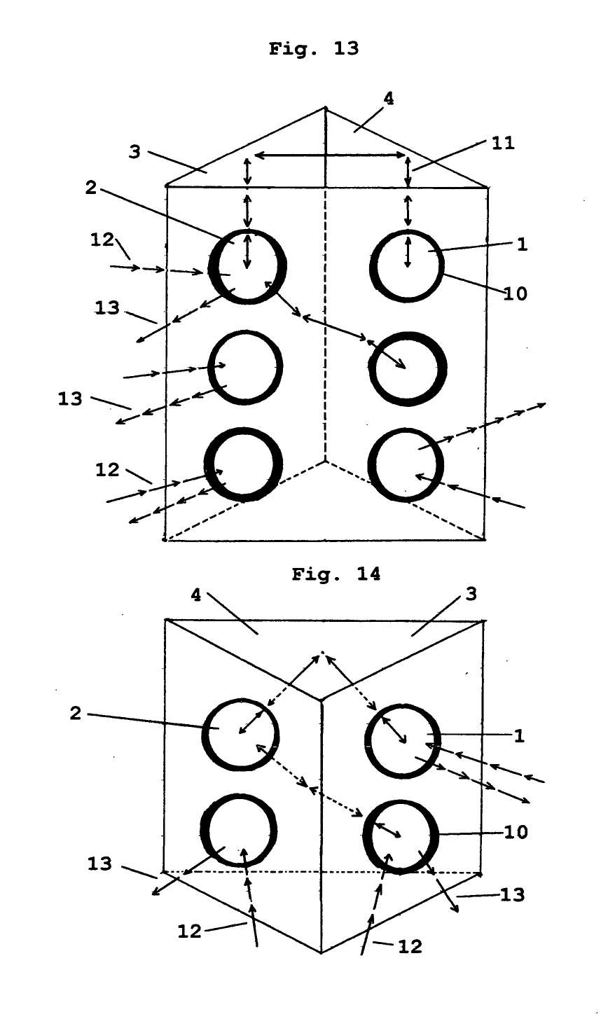

FIG. 13; Longitudinal right angled prism similar to FIG. 12b. Integrated horizontally and vertically aligned optic bodies part of the hypotenuse surface direct incoming light toward opposing leg surfaces correlated to correspond to two or more light receiving and transmitting optic bodies. Light is exchanged both horizontally and vertically between optic portions in a retro-reflective manner.

FIG. 14; A right angled prism bar similar to FIG. 12a. Optical portions are united with two prismatic longitudinal surfaces enabling exchange of light in several planes. Light is mainly redirected 90 degrees.

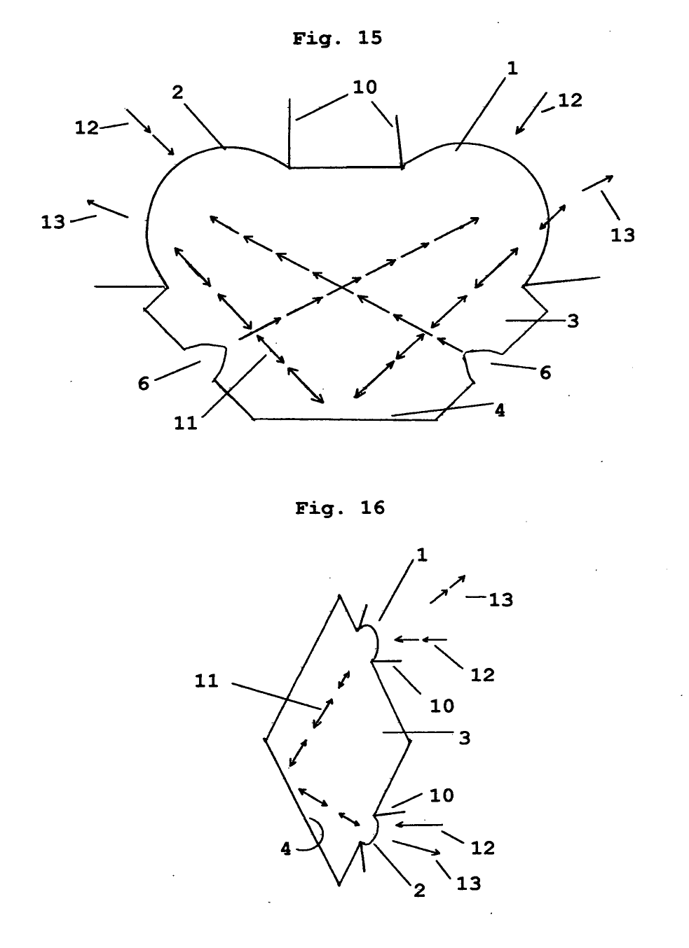

FIG. 15; Corners of a right angle prism have been modified to accommodate refractive lens formations as well as light emitting diodes so that light may be project from within as well as receiving light from and exterior light source.

FIG. 16; A modified rhombus or rhomboidal prism arranged to interchangeably exchange light between optical portions integrated at either end of prism.

### DETAILED DRAWINGS

FIG. 1a; Generalised longitudinal side view of a Light Distribution Unit. Shows a general embodiment of a Light Distribution Unit in which an internally reflecting chamber 3 acts as a mutual relay station for propagation of light 11 between two or more proximally arranged interacting optic bodies 1 and 2. Optical bodies 1 and 2 receive light 12 directly from an external light source 9 and via surrounding light collecting reflectors 10 or surrounding lenses (not shown). Optic bodies coupled to Distribution unit feed light to an internally reflecting chamber 3 for further dispatchment.

Received light is counter reflected 11 by means of specular and diffuse reflection off reflecting surfaces 4 and directed toward opposing optic body or any optic bodies confined to the reflecting chamber. There exists at least a two way flow of light between symbiotically activated optic bodies. Refraction results as speed and wavelength is altered while passing through various mediums between optic bodies. There may be a spaced relation between cohabiting optic bodies or they may be physically aligned so that certain optical portions are in contact with one another. The close proximity will permit direct transfer of rays between optic bodies as well as via reflective surfaces. A polarizing layer 7 covers some or all reflective surfaces so that it may interfere with internal reflection and cause a flickering or blinking sensation. Reactive material in the form of phosphorescents, fluorescents or luminescents 5 may be suitably incorporated inside the reflecting chamber and excited or stimulated by incoming light 11 or light derived from an internal light source 6 or induced currents from secondary coils 8 receiving energy from distant primary coils (not shown).

FIG. 1b; shows a side view or short end of FIG. 1a.

FIG. 1c; shows a top view or aerial perspective of FIG. 1a.

FIG. 2; Side view of light receiving 12 optic bodies 1 & 2 shaped as bulbs have tapered ends plugged into aperture sockets of an internally reflecting chamber 3 in order to internally reflect incoming rays 11 via specular reflection off reflecting surfaces 4 so that either side may mutually emit light 13 to external surrounding. Polarizing layer 7 covers reflective surface which may be activated to regulate reflecting characteristics. A dimming effect may be achieved when reflection is hindered due electrical polarization of the crystal layer.

FIG. 3; Side view of Light Distributing unit showing reflectors 10 concentrating light 12 from a distant light source 9 onto tapering portions of conical or pyramidal optic bodies 1 and 2 so that internal portions of proximally arranged optic bodies may reciprocally share and reflect light 11 in unison directly amongst each and every optic body as well as indirectly via specular and diffuse reflection off surrounding chamber walls 3.

FIG. 4; Side view of fused or single optic body acquiring a plurality of exteriorly protruding optical portions 1 lodged in light receiving reflectors 10. Internally received light may be counter reflected onto a reflecting surface 4 via a partitional space or medium 7 in order to refract and reflect light 1 lthrough the chamber and effect transmission of light 13.

FIG. 5. Cross-sectional side view of a Light Distributing unit operated by an internal light source 6 penetrating internally reflecting chamber 3.

Light 6 excites electrons within reactive fluorescent or phosphorescent material 5 with resultant release of photons and visible light of longer wavelength 14, internally reflected within chamber 3 and externally emitted via optic bodies 1 and 2.

FIG. 6; Cross-sectional side view or top view of a Light Distribution unit showing how light 11 may simultaneously criss-cross directly between optic bodies 1 and 2 as well as via counter reflecting surfaces. Light is received by a plurality of external reflectors 10 surrounding optic bodies 1 and 2. Concentrated light is further conveyed into chamber 3 and projected onto internal surrounding structures 11. Internally reflected light is then reflected out 13 in all directions.

FIG. 7: Aerial view of a pentagonal light distribution unit in cross-section. A plurality of optic bodies set in circular formation 1 & 2 direct projected light 11 to multifaceted angled mirror surfaces 4 just below each optic body contained within internally reflecting chamber 3, in order to distribute light to opposing neighbouring optic bodies in concentrated fashion. The floor of the reflecting chamber may be of conical or pyramidal shape so that light may be projected by optic bodies toward tapering or convergent ends beneath each adjacent optic body in order to be counter reflected and directed illuminating all proximally arranged optic bodies in three dimensional space. A variety of polygon configurations may be made having modified counter reflecting floors, sides and roofing arranged to correspond to directional requirements. Reflecting chamber may have troughs and spikes following contours of curves and lines including depressions and elevations of all available types.

FIG. 8; Sectional side view of FIG. 7's pyramidal reflector chamber 4 exchanging rays 11 between reflective surface 3 and optic bodies 1 and 2. Transmission of light is accomplished between all optic bodies part of the pentagon.

FIG. 9; Side view of a light capturing and distribution unit. Illustrating a pre-synaptic primary optic body 1, supplying energy in the form of concentrated light via a multitude of light diodes 6, directed toward a tapering light guide's vortex. Adjacent post-synaptic secondary optic bodies 2, receive incoming concentrated light via a junctional gap or cleft within the chamber 3, via specular reflection.

Opposing post-synaptic secondary optic bodies 2 are able to receive and exchange light directly between themselves due to their close proximity and the fact that light tends to travel linearly. All post-synaptic secondary optic bodies may simultaneously act as receives and transmitters of internal light as well as external ambient light 9 using exterior embracing light collecting reflectors 10.

FIG. 10; Top view of a triangular light collector and distribution unit. Optic bodies 1 and 2 are integrated into tapered ends of parallel, compound parabolic concentrators penetrating the hypotenuse. Light directed by optic bodies toward each internal reflective leg of the triangle will be counter reflected to the opposing side. Compound parabolic concentrator components including optic bodies may be adjustable so that light may be calibrated for reception and transmission of light along selected co-ordinated points along the reflective angled legs of the triangle. Thus they need not be aligned at 90 degrees to one another as is the custom concerning prior art prism retro-reflectors utilizing exterior optical portions. Prior art encounters disturbing exterior surface reflections when altering angles of approach deviant from perpendicular settings. Modified prismatic versions may employ a variety of shapes of optical bodies with light capturing instruments.

FIG. 11; General view of a pyramidally shaped light distribution unit. Multiple Optic bodies 1, lodged in windows along the divergent end of the pyramid are able to counter reflect light similar to that described in FIG. 10. The range and number of optical bodies may vary depending upon the number of sides of the pyramid.

FIG. 12a,b,c; Modified versions of light distribution units using right angled prisms. Modification may be accomplished by cutting glass crystal prisms or casting synthetic prisms so that optic portions be shaped at defined exit and entry points. Generally this will imply that such points occur when the critical angle of reflection is reached or surpassed where total internal reflection or external reflection naturally occurs along a plane reflective surface. In essence the altered surface outline waivers the critical angle, allowing light to be refracted by an optical body instead of reflected by a flat surface. A further modification would be to alter the surface outline using engraved Fresnel lenses on prism surfaces or bond lenses as layers at specific zones.

FIG. 12a demonstrates a leg-hypotenuse-leg orientation and FIG. 12b a hypotenuse-leg-leg orientation. FIG. 12c a hypotenuse-leg orientation.

FIG. 12a; Depicts a cross section of a modified right angle prism acting as a light distribution chamber. Organized according to a refractive leg-reflective hypotenuse-refractive leg orientation. Surrounding exterior ambient light or light from a distant light source 12, is collected and concentrated by tapered exterior reflectors 10, onto multifaceted refractive protrusions part of the triangle's leg surface structure 1, enabling light to enter internally reflecting prism chamber 3, wherein internally reflected incidental light 11, is reflected off the hypotenuse 4, toward opposing leg and refractive surface area 2, in line with the angle of reflection followed by emittance of light exteriorly 13. Light may be mutually exchanged alternatively or simultaneously between opposing legs.

FIG. 12b; Demonstrates a cross section of a variation of a right angled prism mimicking a light distribution chamber with an arrangement comprising refractive hypotenuse-reflective leg-reflective leg-refractive hypotenuse. Concentrated external light 12 enters one or more refractive portions 1 and 2, bonded to or part of the hypotenuse surface. Internally reflected light 11 is strikes reflective surfaces 4 of both legs causing light to be retro-reflected through one or more refractive portions. A further modification may allow light to enter a corner section of the hypotenuse and adjacent leg and be counter reflected onto the opposing leg so that light may escape through the hypotenuse.

FIG. 12c; A graphical example of a cross section of a modified right triangle having refractive surfaces along the hypotenuse and one of the legs. External light 12 may enter from both the hypotenuse and leg enabling a constant flow of light 11, between refractive surfaces 1 and 2 via one of the prisms reflective legs.

FIG. 13; Shows an overall front view of a right angled prism bar. Integrated optical refractive portions 1 and 2 are aligned in parallel rows along the hypotenuse so that light may be mutually retro-reflected via the two reflective legs. Light may be reflected at right angels or in an oblique manner.

FIG. 14; The drawing shows a general view of a right angled prism bar employed as a reflective chamber. Light entering either leg is redirected via the hypotenuse and issues in and out of Fresnel lenses engraved into leg surfaces or other refractive bodies 1 and 2.

FIG. 15; Cross section of a hybrid lamp using both ambient light and artificial light. May be made of a solid right angled prism or cavernous reflecting chamber. Light emitting diodes 1 or electro-luminescents project light 11 directly toward opposing refractive portions 1 and 2. Refractive portions may respectively simultaneously receive and transmit concentrated ambient light via specular reflection. Thus there may exist a two way flow of ambient light as well as bi-directional projection of electrically generated light through all refractive bodies.

FIG. 16; A modied rhombus or rhomboidal prism re-directs light between designated refractive surfaces 1 and 2 via an internally reflecting surface 4.

1. A light capturing and distributing unit acting as a synaptic junction between optic bodies, comprising an external light source (9), at least two reciprocally interacting proximally arranged light receiving and transmitting optic bodies (1) and (2), extending from an internally reflecting distribution chamber (3), wherein at least a first optic body (1), is analogous or congruent to the angle of incidence and at least a second optic body (2), is analogous or congruent to the angle of reflection, with respect to the normal of a reflective surface within said distribution chamber (3), enabling mutual exchange of light (11) between said optic bodies with resultant illumination of said optic bodies.

2. A light capturing and distributing unit acting as a relay station between optic bodies, comprising an external light source (9), at least two proximally arranged refractive optic bodies (1) and (2), perturbing and integrating reflective surfaces of an internally reflecting distribution chamber (3), allowing refraction instead of reflection to occur spontaneously at the critical angle of reflection, wherein at least a first refractive optic body (1), is analogous or congruent to the angle of incidence and at least a second refractive optic body (2), is analogous or congruent to the angle of reflection, with respect to a reflective surface, contained within reflecting chamber, enabling mutual exchange of light (11) between said optic bodies so that light may freely enter and exit said internally reflecting chamber.

3. A light capturing and distributing unit according to any preceding claims, wherein mutual exchange of light between proximal optic bodies (1) and (2), is primarily enabled by direct one stage sequential specular reflection occurring between intermediary reflective transmissive medium and said optic bodies, as opposed to multiple intermediate reflections occurring between points of transfer.

4. A light capturing and distributing unit according to any preceding claims, wherein mutual exchange of light between proximal optic bodies (1) and (2), is primarily enabled by direct two stage specular reflection occurring between reflective transmissive medium and said optic bodies, as opposed to multiple intermediary reflections occurring between points of transfer.

5. A light capturing and distributing unit according to any preceding claims, wherein specular reflection occurs via a planar reflective transmissive surface.

6. A light capturing and distributing unit according to any preceding claims, wherein specular reflection occurs via a curved reflective transmissive surface.

7. A light capturing and distributing unit according to any preceding claims, wherein the light distribution chamber (3) has an internal light source (6).

8. A light capturing and distributing unit according to any preceding claims, wherein the light distribution chamber (3) is lined by polarizing layers so that reflection may occur intermittently and thereby enable a flickering light.

9. A light capturing and distributing unit according to any preceding claims, wherein energy is transferred from a distant primary coil to a secondary coil (8) accompanying light distribution unit.

10. A light capturing and distributing unit according to any preceding claims, wherein light may be received and transmitted 360 degrees.

11. A light capturing and distributing unit according to any preceding claims, wherein exterior portions of optic bodies (1), (2) are lodged in convergent apertures of light collecting reflectors in order to provide concentrated light to said optic bodies.

12. A light capturing and distributing unit according to any preceding claims, wherein internally reflecting chamber houses material which may fluoresce/luminesce and/or phosphoresce.

13. A light capturing and distributing unit according to any preceding claims, wherein refractive optic bodies contain material which may fluoresce or luminesce.

14. A light capturing and distributing unit according to any preceding claims, wherein refractive optic bodies have tapered shapes so that light may be collected by surface area of said optic bodies and transmitted toward convergent ends or vice versa.
